(19) United States
(12) Patent Application Publication
(10) Pub. No.: US 2015/0325265 A1
(43) Pub. Date: Nov. 12, 2015

(54) MAGNETIC TAPE DEVICE AND METHOD FOR CONTROLLING MAGNETIC TAPE DEVICE

(71) Applicant: FUJITSU LIMITED, Kawasaki-shi (JP)

(72) Inventor: Tsukasa MINEMURA, Nagano (JP)

(21) Appl. No.: 14/608,398

(22) Filed: Jan. 29, 2015

(30) Foreign Application Priority Data
May 7, 2014 (JP) 2014-095716

(51) Int. Cl. G11B 15/68

(52) U.S. Cl. CPC G11B 15/6885

(57) ABSTRACT

A magnetic tape device, includes: a base member movable in a front-back direction of a cabinet; a tape drive mounted rotatably to the base member at least between a first position facing a front surface of the cabinet and a second position facing a side surface of the cabinet; and a rotation unit configured to rotate the tape drive from the first position to the second position when a magazine detachably containing a magnetic tape cartridge is inserted into the cabinet, and to rotate the tape drive from the second position to the first position when the magazine is removed from the cabinet.

### CROSS-REFERENCE TO RELATED APPLICATION

This application is based upon and claims the benefit of priority of the prior Japanese Patent Application No. 2014-095716 filed on May 7, 2014, the entire contents of which are incorporated herein by reference.

### FIELD

The embodiments discussed herein are related to a magnetic tape device and a method for controlling a magnetic tape device.

### BACKGROUND

In an information processing system, a magnetic tape device which backs up data is utilized in order to avoid disappearance of important data or the like.

The related art is disclosed in Japanese Laid-open Patent Publication No. 2003-178501.

### SUMMARY

According to an aspect of the embodiments, a magnetic tape device, includes: a base member movable in a front-back direction of a cabinet; a tape drive mounted rotatably to the base member at least between a first position facing a front surface of the cabinet and a second position facing a side surface of the cabinet; and a rotation unit configured to rotate the tape drive from the first position to the second position when a magazine detachably containing a magnetic tape cartridge is inserted into the cabinet, and to rotate the tape drive from the second position to the first position when the magazine is removed from the cabinet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a magnetic tape device;

FIG. 2 illustrates an example of a magnetic tape device;

FIG. 3 illustrates an example of a magnetic tape device;

FIG. 4 illustrates an example of a magnetic tape device;

FIG. 5 illustrates an example of a spring plunger;

FIG. 6 illustrates an example of a base member;

FIG. 7 illustrates an example of a magazine;

FIG. 8 illustrates an example of an actuator;

FIG. 9 illustrates an example of a transport unit;

FIG. 10 illustrates an example of a transport unit;

FIG. 11 illustrates an example of a transport unit;

FIG. 12 illustrates an example of a transport unit;

FIG. 13 illustrates an example of a rotation unit;

FIG. 14 illustrates an example of a unit to control a rotation of a tape drive;

FIG. 15 illustrates an example of a sensor;

FIG. 16 illustrates an example of a sensor;

FIG. 17 illustrates an example of a backup operation;

FIG. 18 illustrates an example of a method for movement of a tape drive;

FIG. 19 illustrates an example of an order in which a tape drive moves;

FIG. 20 illustrates an example of a transport unit;

FIG. 21 illustrates an example of a transport of a transport unit;

FIG. 22 illustrates an example of a transport of a transport unit; and

FIG. 23 illustrates an example of an ejection of a transport unit.

### DESCRIPTION OF EMBODIMENTS

Magnetic tape devices include a single-unit magnetic tape device in which a magnetic tape cartridge is manually replaced, and a magnetic tape device with an autoloader function in which plural magnetic tape cartridges contained in a magazine are replaced by the autoloader. In the single-unit magnetic tape device, the magnetic tape cartridge is inserted into a tape drive, and thereafter, data backup is started in a short time. In the magnetic tape device with the autoloader function, data backup is performed without manual operation, while at the start of the data backup, operation is performed in which all magnetic tape cartridges are transported to the tape drive and volumes are read in. Thus, in an information processing system, the single-unit magnetic tape device is utilized for data backup during time periods in which operator's operation is expectable (for example, in the daytime), and the magnetic tape device with the autoloader function is utilized for data backup during time periods in which the operator's operation is not expectable (for example, at night).

For example, in a case where the information processing system including only the magnetic tape device with the autoloader function is operated, a volume reading operation is performed every time the magnetic tape cartridge is manually replaced, and thus, backup efficiency may be reduced.

Thus, a magnetic tape device including the single-unit magnetic tape device integral with the magnetic tape device with the autoloader function may be provided.

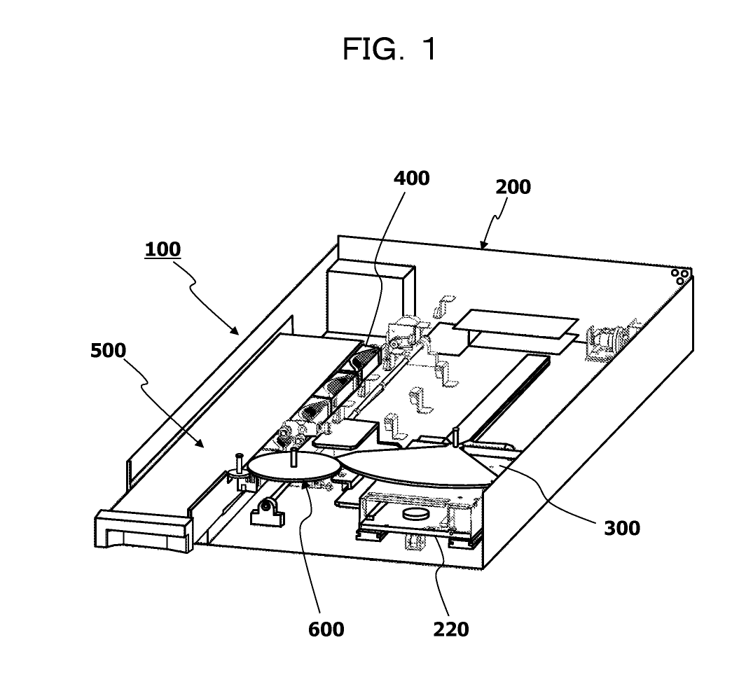

FIG. 1 illustrates an example of a magnetic tape device. FIG. 1 illustrates a perspective view of the magnetic tape device. A magnetic tape device 100 illustrated in FIG. 1 is illustrated with its top plate or front panel removed in order that its internal structure may be readily seen; the same applies hereinafter.

The magnetic tape device 100 includes a base member 220 and a tape drive 300. The base member 220 is movable in a front-back direction of a cabinet 200. The tape drive 300 is rotatably mounted between a first position facing a front surface of the cabinet 200 and a second position facing a side surface of the cabinet 200. The magnetic tape device 100 includes a rotation unit 600 configured to rotate the tape drive 300 between the first position and the second position according to the insertion or removal of a magazine 500 in which plural magnetic tape cartridges 400 are detachably contained. The rotation unit 600 rotates the tape drive 300 from the first position to the second position when the magazine 500 is inserted into the cabinet 200, while the rotation unit 600 rotates the tape drive 300 from the second position to the first position when the magazine 500 is removed from the cabinet 200.

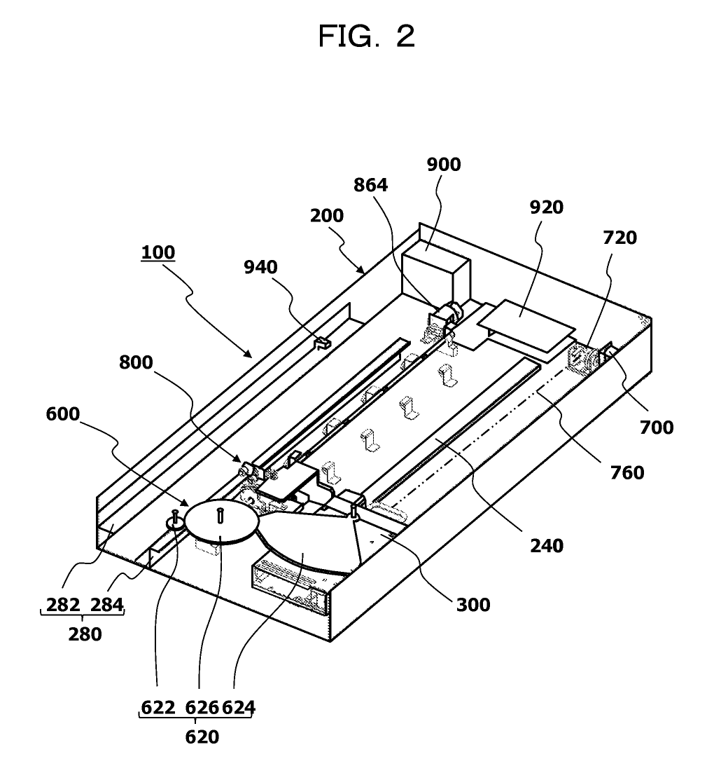

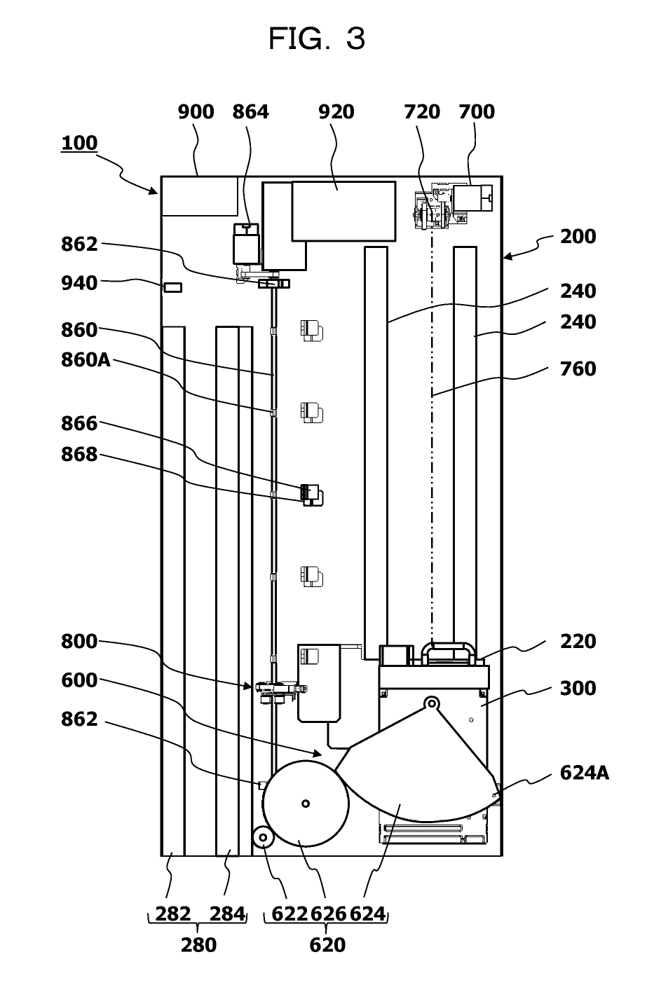

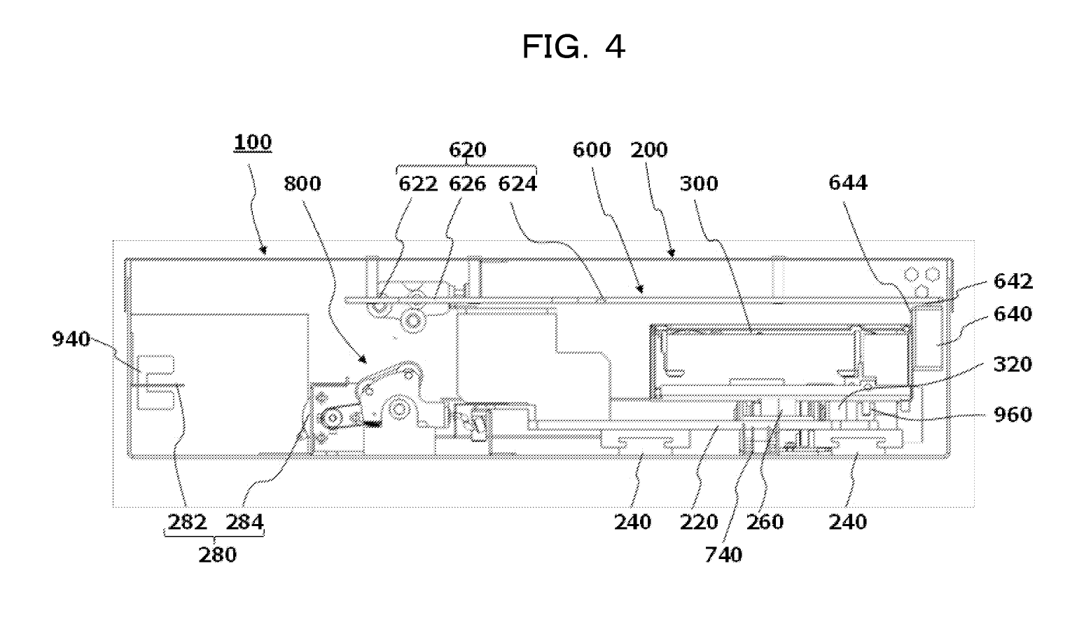

FIGS. 2 to 4 illustrate an example of a magnetic tape device. FIG. 2 illustrates a perspective view of the magnetic tape device, FIG. 3 illustrates a plan view of the magnetic tape device, and FIG. 4 illustrates a front view of the magnetic tape device. As illustrated in FIGS. 2 to 4, a pair of rails 240 extending in parallel to the front-back direction of the cabinet 200 are fixed to a right-side bottom surface of the cabinet 200 substantially in the shape of a rectangular parallelepiped. The pair of rails 240 are mounted with the base member 220 made of a substantially rectangular plate material, which is movable (or slidable) along an extending direction of the rails 240. For example, the base member 220 contacts an upper surface of the rails 240 and also fits in recessed portions formed in both side surfaces of the rails 240, thereby to suppress the base member 220 coming off the rails 240. Thus, the base member 220 is movable in the front-back direction of the cabinet 200.

A solid or hollow cylindrical rotating shaft 260 is fixed to an upper surface of the base member 220. The tape drive 300 is rotatably fixed to the rotating shaft 260 by a bearing or the like. A configuration given below limits a rotation of the tape drive 300 to between the first position and the second position and allows the tape drive 300 to be held (or fixed) at the first position or the second position.

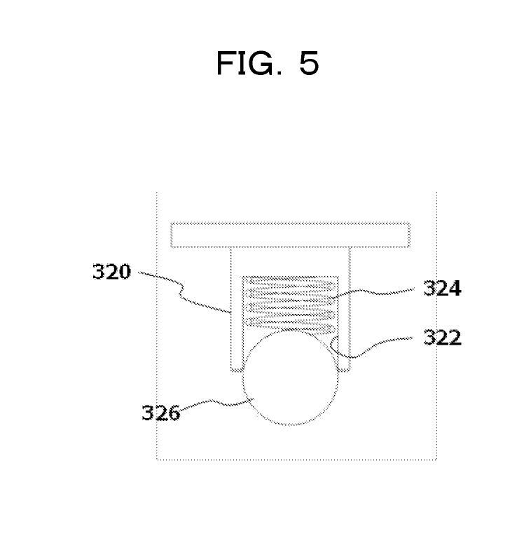

For example, a proximal end portion of a spring plunger 320 protruding downward toward the upper surface of the base member 220 is fixed to a lower surface of the tape drive 300. FIG. 5 illustrates an example of a spring plunger. FIG. 5 illustrates a longitudinal sectional view of the spring plunger 320. The spring plunger 320 has a substantially cylindrical shape as illustrated in FIG. 5. A circular hole 322 is formed in the spring plunger 320 from its distal end surface toward its proximal end portion, and a compression coil spring 324 and a ball 326 made of metal are accommodated in the circular hole 322. While being biased toward its distal end portion by the compression coil spring 324, the ball 326 is displaceable toward its proximal end portion when an external force becomes greater than a biasing force. Note that the spring plunger 320 may have a configuration illustrated in FIG. 5, or may be configured as a known spring plunger.

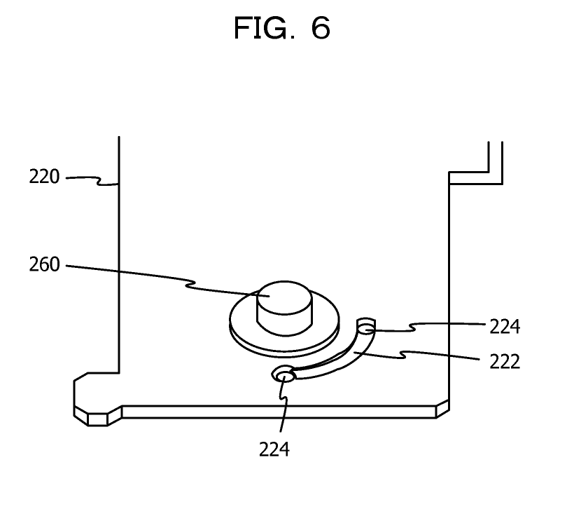

FIG. 6 illustrates an example of a base member. FIG. 6 illustrates a perspective view of a shape of the upper surface of the base member. As illustrated in FIG. 6, an arcuate groove 222 having an arcuate shape having a central angle of approximately 90°, while keeping equal a distance from a center of the rotating shaft 260, is formed in the upper surface of the base member 220. The arcuate groove 222 has a cross section having a substantially arcuate shape according to an external shape of the ball 326 of the spring plunger 320. A portion of the ball 326 is fitted in the arcuate groove 222 thereby to limit the rotation of the tape drive 300 to between the first position and the second position. Spherical holes 224 deeper than an intermediate portion are formed in both end portions of the arcuate groove 222. The ball 326 of the spring plunger 320 is fitted in the spherical holes 224 thereby to hold the tape drive 300 at the first position or the second position.

A driving pulley 720 and a driven pulley 740, which are driven by a servomotor 700, are mounted on the bottom surface of the cabinet 200 in order to move the tape drive 300 formed integrally with the base member 220, along the rails 240. A belt 760 including a material having elasticity, for example, is entrained between the driving pulley 720 and the driven pulley 740. The base member 220 is fixed to the belt 760. Thus, the servomotor 700 is actuated to rotate the belt 760 entrained between the driving pulley 720 and the driven pulley 740 and move the tape drive 300 formed integrally with the base member 220, along the rails 240.

A magazine rail 280 extending in the front-back direction of the cabinet 200 and holding the magazine 500 at a certain position is fixed to the left side surface and bottom surface of the cabinet 200. The magazine rail 280 includes a first rail member 282 supporting the left side surface and the left-side bottom surface of the magazine 500 on the left side surface of the cabinet 200, and a second rail member 284 supporting a lower portion of the right side surface and the bottom surface of the magazine 500 on the bottom surface of the cabinet 200. Thus, under a condition where the magazine 500 is placed on the magazine rail 280, the magazine 500 is supported at least at both its side surfaces and its bottom surface by the first rail member 282 and the second rail member 284 and is thus restrained from moving leftward and rightward and moving downward.

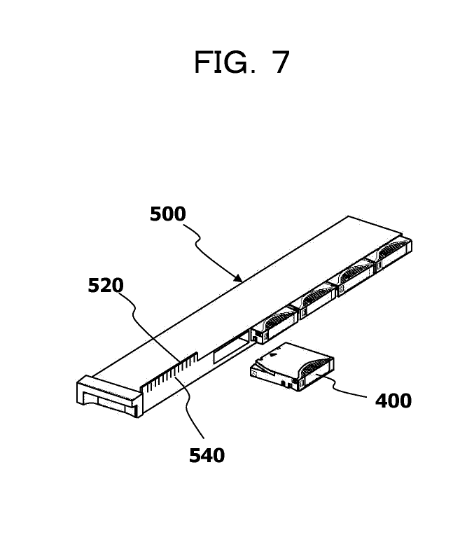

The cabinet 200 is mounted with the rotation unit 600 configured to rotate the tape drive 300 toward the first position or the second position according to the insertion or removal of the magazine 500. FIG. 7 illustrates an example of a magazine. FIG. 7 illustrates a perspective view of the magazine. As illustrated in FIG. 7, the rotation unit 600 includes a rack 540 formed on an outer side surface of a plate member 520 extending upward from one side surface of the magazine 500, and a gear train 620 rotatably mounted on a top plate of the cabinet 200. The gear train 620 includes a first gear 622 capable of meshing with the rack 540 of the magazine 500, a substantially fan-shaped second gear 624 arranged concentric with the rotating shaft 260 of the tape drive 300, and a third gear 626 to mesh with the first gear 622 and the second gear 624. The first gear 622 and the second gear 624 may mesh with the third gear 626 at all times. The first gear 622, the second gear 624 and the third gear 626 rotate around the rotating shaft extending vertically.

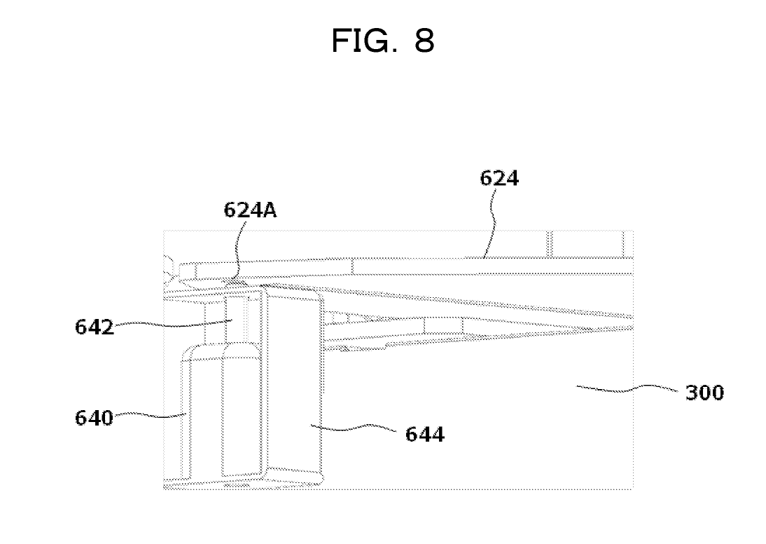

In response to rotation of the second gear 624, the tape drive 300 rotates between the first position and the second position. Thus, a fitting hole 624A in which a tip portion of a pin 642 of an actuator 640 is fitted is formed in one end portion of an arc of the second gear 624. FIG. 8 illustrates an example of an actuator. FIG. 8 illustrates a perspective view of the actuator for the rotation unit. As illustrated in FIG. 8, the actuator 640 in which the pin 642 enters and exits according to whether or not a current is passed through a solenoid is mounted to one side surface of the tape drive 300 by a bracket 644 having a substantially U-shape. The actuator 640 causes the pin 642 to protrude when the current is not passed through the solenoid, while the actuator 640 retracts the pin 642 when the current is passed through the solenoid. Under a condition where the pin 642 of the actuator 640 is fitted in the fitting hole 624A of the second gear 624, the tape drive 300 is integral with the second gear 624. Thus, the tape drive 300 rotates in response to the rotation of the second gear 624. Meanwhile, under a condition where the pin 642 of the actuator 640 is not fitted in the fitting hole 624A of the second gear 624, the tape drive 300 is not integral with the second gear 624. Thus, the tape drive 300 freely moves in the front-back direction of the cabinet 200.

The base member 220 is mounted with a transport unit 800 configured to transport the magnetic tape cartridges 400 between the tape drive 300 and the magazine 500 under a condition where the tape drive 300 directly faces the magazine 500 after rotating to the second position.

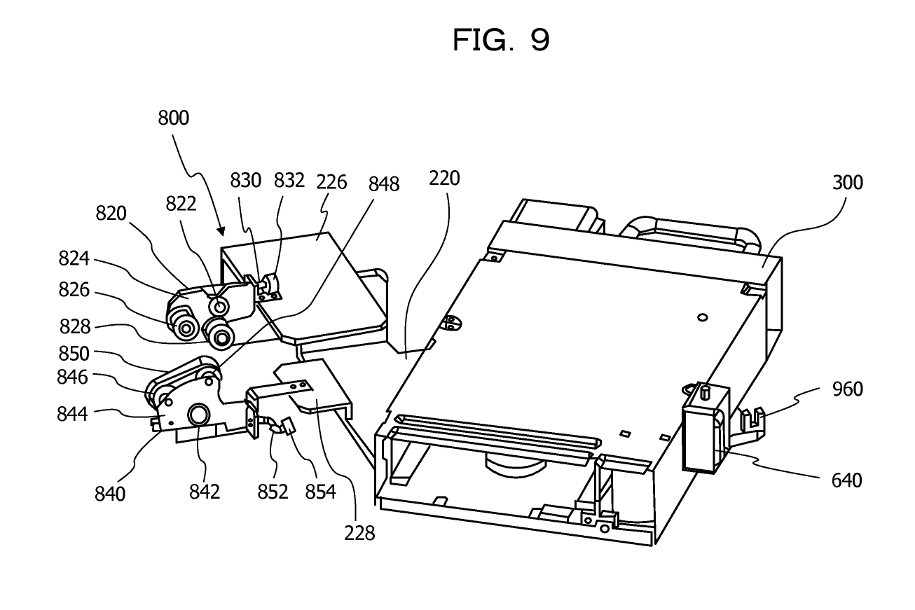

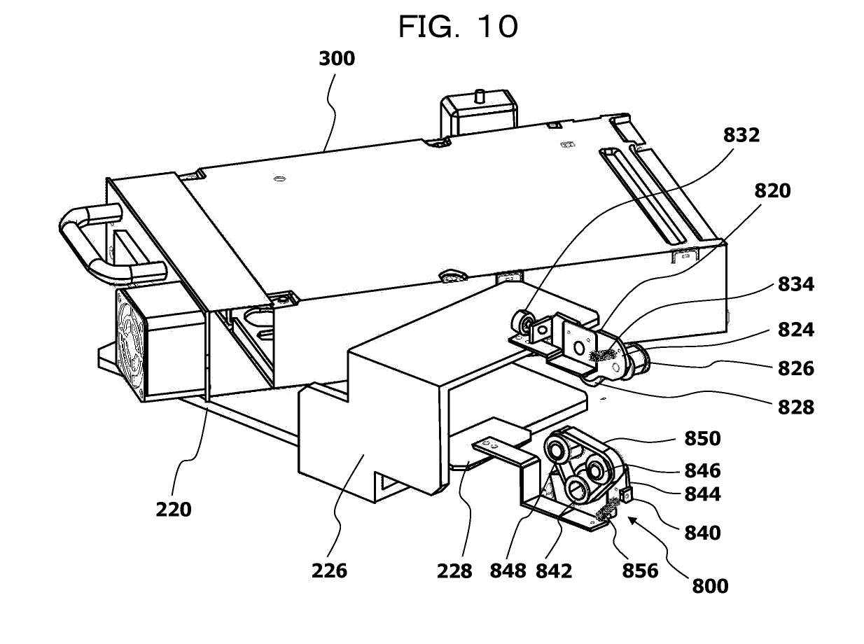

FIGS. 9 and 10 illustrate an example of a transport unit. FIG. 9 illustrates a perspective view of the transport unit as seen from the front of the cabinet. FIG. 10 illustrates a perspective view of the transport unit as seen from an underside of the cabinet. As illustrated in FIGS. 9 and 10, the transport unit 800 includes a first transport member 820 and a second transport member 840 which transport the magnetic tape cartridge 400 with its upper and lower surfaces pinched therebetween. The first transport member 820 is mounted in such a way as to protrude from the base member 220 toward the magazine rail 280, by a first bracket 226 located on a back portion side in the front-back direction of the cabinet 200 and standing in a substantially U-shape from one end portion of the base member 220. The second transport member 840 is mounted in such a way as to protrude from the base member 220 toward the magazine rail 280, by a second bracket 228 located on the magazine rail 280 side and standing in a substantially U-shape from the one end portion of the base member 220.

The first transport member 820 includes a swinging plate portion 824, and two rollers 826 and 828. The swinging plate portion 824 is swingable around a rotating shaft 822 extending in the front-back direction of the cabinet 200. The two rollers 826 and 828 are spaced apart from each other and fixed to a lower portion of the swinging plate portion 824. At least one of the rollers may be fixed to the lower portion of the swinging plate portion 824. A roller 832 rotatable around a rotating shaft 830 extending in a width direction of the cabinet 200 is fixed to an end portion of the swinging plate portion 824 located on the base member 220 side.

The second transport member 840 includes a swinging plate portion 844, and two rollers 846 and 848. The swinging plate portion 844 is swingable around a cylindrical portion 842 having a substantially cylindrical shape, which functions as a rotating shaft extending in the front-back direction of the cabinet 200. The two rollers 846 and 848 are spaced apart from each other and fixed to an upper portion of the swinging plate portion 844. At least one of the rollers may be fixed to the upper portion of the swinging plate portion 844. The cylindrical portion 842 is rotatably fixed to the swinging plate portion 844, for example by a bearing. A hole having a noncircular shape such as a polygonal shape (for example, an equilateral hexagonal shape) is formed in a center of the cylindrical portion 842. A belt 850 including a material having elasticity is entrained between the cylindrical portion 842 and the two rollers 846 and 848. When the cylindrical portion 842 rotates, its rotating force is transmitted via the belt 850 to the two rollers 846 and 848, so that the rollers 846 and 848 rotate. A roller 854 rotatable around a rotating shaft 852 having a portion extending in the width direction of the cabinet 200 is fixed to an end portion of the swinging plate portion 844 located on the base member 220 side.

The swinging plate portion 824 of the first transport member 820 and the swinging plate portion 844 of the second transport member 840 are biased by tension coil springs 834 and 856 in a direction in which the swinging plate portions 824 and 844 move away from each other. Under a condition where an external force does not act on the swinging plate portions 824 and 844, there is a great distance between the rollers 826 and 828 of the first transport member 820 and the rollers 846 and 848 of the second transport member 840. Thus, the first and second transport members 820 and 840 may not perform the function of transporting the magnetic tape cartridge 400 with it pinched therebetween.

A bottom portion of the cabinet 200 is provided with a rotatable drive shaft 860 extending in the front-back direction of the cabinet 200 in such a way as to pass through the cylindrical portion 842 of the second transport member 840 of the transport unit 800. Both end portions of the rotatable drive shaft 860 are rotatably supported by a pair of bearing members 862 fixed to the bottom surface of the cabinet 200. The rotatable drive shaft 860 is rotatably driven for example by a servomotor 864. The rotatable drive shaft 860 is provided with large diameter portions 860A each having a larger diameter than other portions and having a polygonal shape, for example, a hexagonal shape. A large diameter portion 860A is formed at an intermediate portion of the rotatable drive shaft 860 directly facing each of cells (or shelves for containing the magnetic tape cartridges 400) of the magazine 500 housed in the cabinet 200. The large diameter portions 860A of the rotatable drive shaft 860 may have a shape according to the hole of the cylindrical portion 842, so as to be rotatable integrally with the cylindrical portion 842 of the second transport member 840. The cylindrical portion 842, the belt 850, the rotatable drive shaft 860 or the servomotor 864 is given as an example of a driving unit.

In response to movement of the tape drive 300, the large diameter portion 860A of the rotatable drive shaft 860 is fitted in the hole in the cylindrical portion 842 of the second transport member 840, and thereby, rotation of the rotatable drive shaft 860 is transmitted to the cylindrical portion 842. Thus, the two rollers 846 and 848 rotate. If the large diameter portion 860A of the rotatable drive shaft 860 is not fitted in the hole in the cylindrical portion 842 of the second transport member 840, the two rollers 846 and 848 of the second transport member 840 do not rotate even if the rotatable drive shaft 860 rotates.

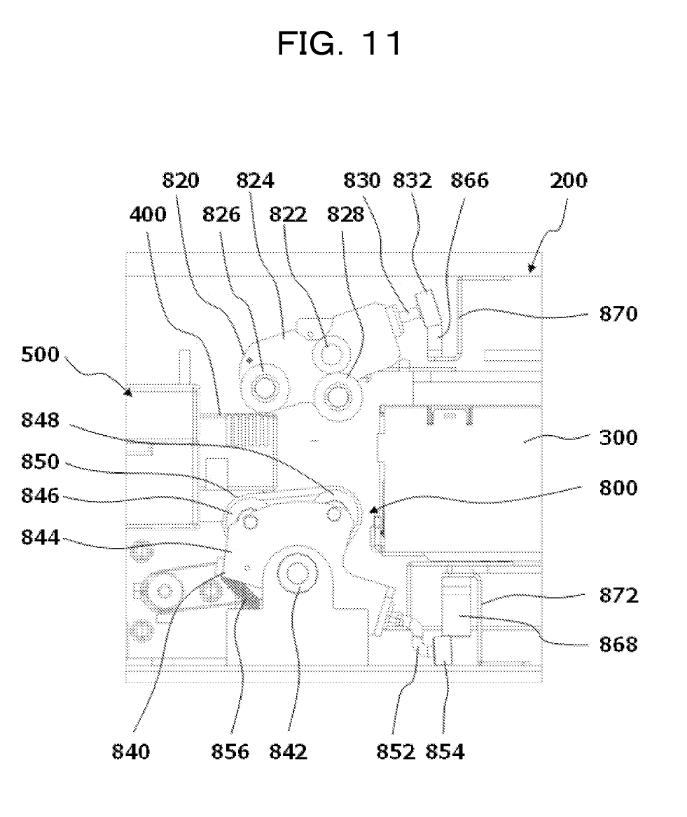

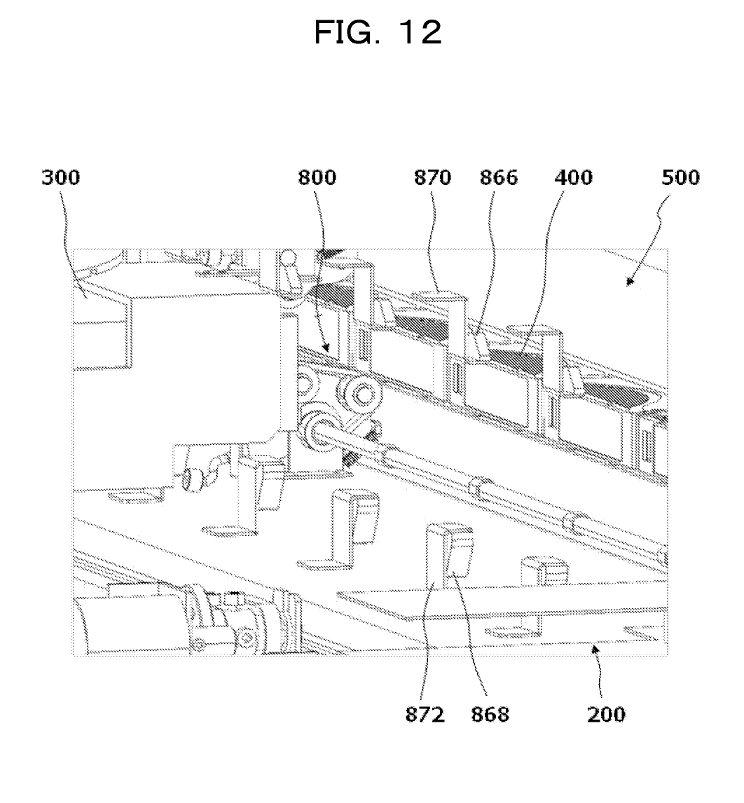

FIG. 11 and FIG. 12 illustrate an example of a transport unit. FIG. 11 illustrates an enlarged partial view of a part of the transport unit. FIG. 12 illustrates a partial perspective view of the part of the transport unit. As illustrated in FIGS. 11 and 12, the top plate and the bottom surface of the cabinet 200 are mounted with a first block 866 and a second block 868, respectively, having a substantially triangular shape as seen in a side view, and configured to swing the swinging plate portion 824 of the first transport member 820 and the swinging plate portion 844 of the second transport member 840, respectively. The first block 866 and the second block 868 are provided at each of positions where the magnetic tape cartridges 400 are pinched between the first transport member 820 and the second transport member 840, for example, at each of positions directly facing the cells of the magazine 500. The first block 866 and the second block 868 are given as an example of a pinching unit.

The first block 866 is mounted by a first bracket 870 hanging down from the top plate of the cabinet 200, in such a manner that an apex of the first block 866 is located downward. The second block 868 is mounted by a second bracket 872 standing from the bottom surface of the cabinet 200, in such a manner that an apex of the second block 868 is located upward. The first block 866 and the second block 868 are each mounted in an orientation in which a height of each block changes along the front-back direction of the cabinet 200.

In response to movement of the tape drive 300, the roller 832 of the first transport member 820 runs up onto the first block 866, and also, the roller 854 of the second transport member 840 runs up onto the second block 868. Thus, the swinging plate portions 824 and 844 swing against biasing forces of the tension coil springs 834 and 856. The distance between the rollers 826 and 828 of the first transport member 820 and the rollers 846 and 848 of the second transport member 840 is reduced, so that the magnetic tape cartridge 400 is pinched therebetween. Proximal end portions of the first transport member 820 and the second transport member 840, for example, may be made of a spring material so as to be capable of absorbing tolerance of the magnetic tape cartridges 400, or the like.

The back portion of the cabinet 200 is mounted with a stabilizer circuit 900 and a controller board 920 as a control system of the magnetic tape device 100, and the stabilizer circuit 900 stabilizes electric power from an external commercial power source, and the controller board 920 controls the tape drive 300, the actuator 640, the servomotors 700 and 864, and the like. A back portion of the magazine rail 280 is mounted with a sensor 940 which outputs an ON signal for example when the magazine 500 is inserted. The upper surface of the base member 220 is mounted with a sensor 960 which outputs an ON signal when the tape drive 300 rotates to the second position.

The output signals from the sensors 940 and 960 are input through signal lines to the controller board 920. The controller board 920 performs electronic control on the tape drive 300 and the servomotors 700 and 864 in response to a command from a host control device (for example, a server or the like). When the output signals from the sensors 940 and 960 both become ON, the controller board 920 operates the actuator 640 to delink the tape drive 300 from the rotation unit 600.

For example, in an initial state, as illustrated in FIG. 2, the magazine 500 is not inserted in the magnetic tape device 100, and the tape drive 300 may rotate to the first position.

In a case where the magnetic tape device 100 is used as the single-unit magnetic tape device, with the magnetic tape device 100 remaining in the state illustrated in FIG. 2, the operator inserts the magnetic tape cartridge 400 into the tape drive 300 through a cartridge insertion port formed in the front panel of the cabinet 200. Thus, after the insertion of the magnetic tape cartridge 400 into the tape drive 300, writing or reading of data is started in a short time, and for example, data backup in the daytime may improve in efficiency. Whether or not to use the magnetic tape device 100 as the single-unit magnetic tape device may be determined for example according to operation of a switch mounted on the front panel or a command from the host control device.

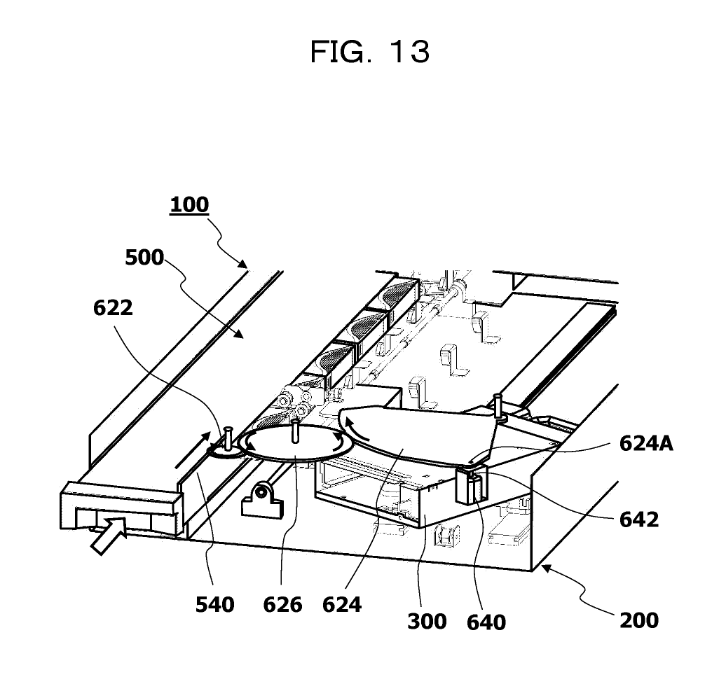

In a case where the magnetic tape device 100 is used as the magnetic tape device with the autoloader function, the operator inserts the magnetic tape cartridges 400 into the cells of the magazine 500, as illustrated in FIG. 7. After that, the operator inserts the magazine 500 containing the magnetic tape cartridges 400 through a magazine insertion port formed in the front panel of the cabinet 200. FIG. 13 illustrates an example of a rotation unit. FIG. 13 illustrates a perspective view illustrating operation of the rotation unit. When the magazine 500 is in process of being inserted into a backmost portion, as illustrated in FIG. 13, the rack 540 formed on the one side surface of the magazine 500 meshes with the first gear 622 of the rotation unit 600, and the first gear 622 rotates according to relative displacements of the rack 540 and the first gear 622. When the first gear 622 rotates, its rotating force is transmitted via the third gear 626 to the second gear 624. At this time, the pin 642 of the actuator 640 is fitted in the fitting hole 624A of the second gear 624, and thus, the tape drive 300 is linked to the rotation unit 600. Thus, in response to rotation of the second gear 624, the tape drive 300 starts rotating from the first position to the second position.

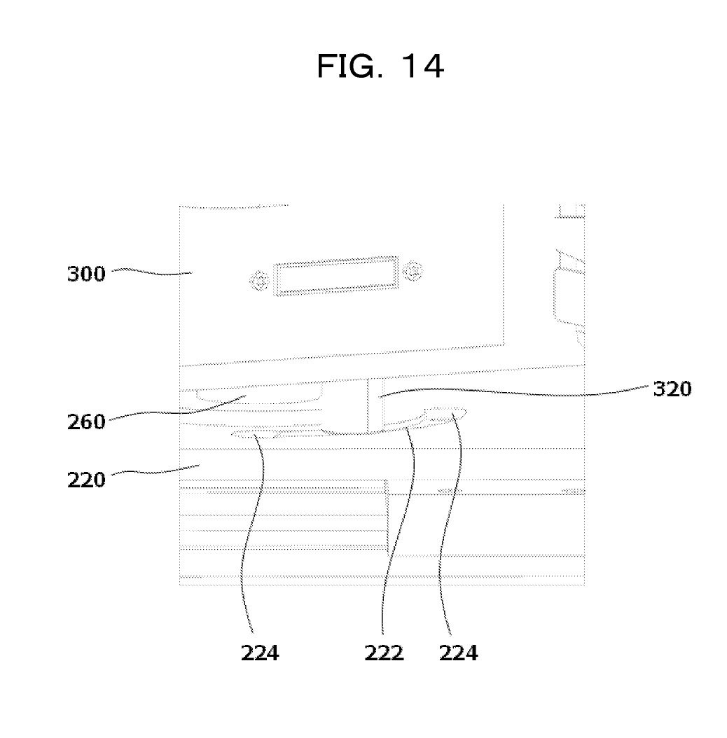

FIG. 14 illustrates an example of a unit to control a rotation of a tape drive. FIG. 14 illustrates a perspective view of the unit to control the rotation of the tape drive between the first position and the second position. In response to rotation of the tape drive 300, the ball 326 of the spring plunger 320 mounted to the lower surface of the tape drive 300 is displaced toward the proximal end portion against a biasing force of the compression coil spring 324 and exits through the spherical holes 224 to the arcuate groove 222 in the base member 220, as illustrated in FIG. 14. When the magazine 500 is inserted into the backmost portion, the tape drive 300 rotates to the second position directly facing the magnetic tape cartridges 400 contained in the magazine 500. When the tape drive 300 rotates to the second position, the ball 326 of the spring plunger 320 mounted to the lower surface of the tape drive 300 is fitted in the spherical hole 224 formed in one end portion of the arcuate groove 222. Under a condition where the ball 326 is fitted in the spherical hole 224, the ball 326 is biased toward the spherical hole 224 by the compression coil spring 324. Thus, even under the action of some external force, the ball 326 does not come off the spherical hole 224, and the tape drive 300 is held at the second position.

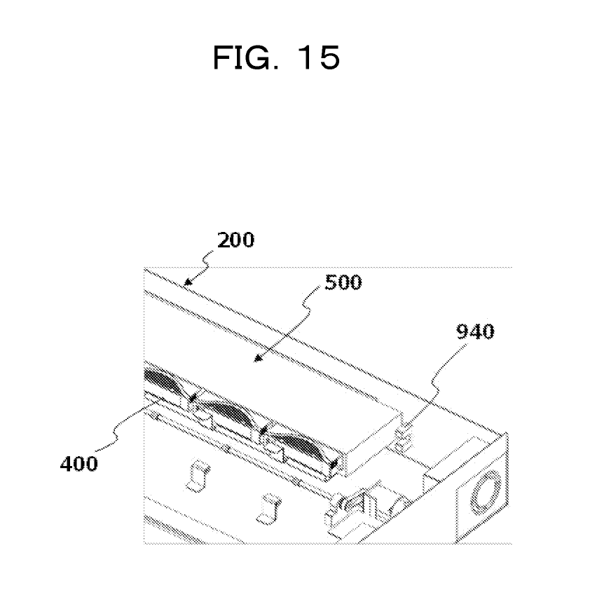

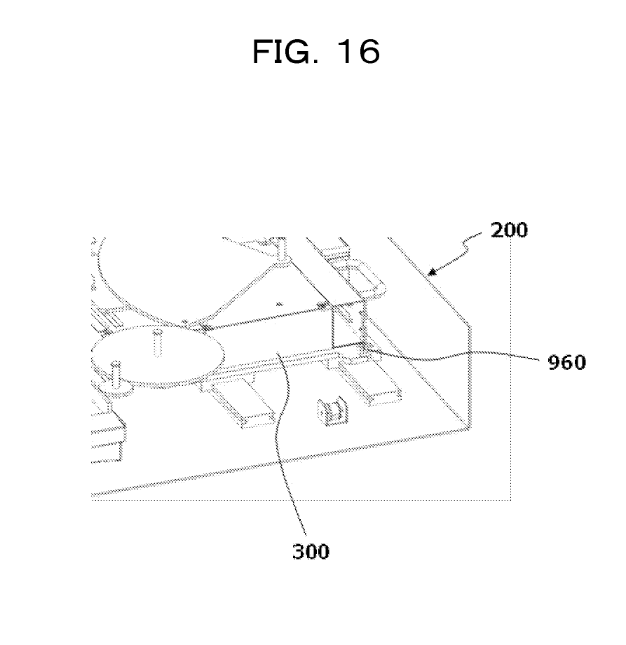

FIGS. 15 and 16 illustrate an example of a sensor. The sensor illustrated in FIG. 15 detects the insertion of the magazine. When the magazine 500 is inserted into the backmost portion, as illustrated in FIG. 15, the sensor 940 detects the magazine 500 and outputs the ON signal to the controller board 920. The sensor illustrated in FIG. 16 detects the rotation of the tape drive to the second position. When the tape drive 300 rotates to the second position, as illustrated in FIG. 16, the sensor 960 detects the tape drive 300 and outputs the ON signal to the controller board 920. When the controller board 920 confirms that the output signals from the sensors 940 and 960 are both ON, the controller board 920 operates the actuator 640 to delink the tape drive 300 from the rotation unit 600. At this time, the controller board 920 may operate the actuator 640 for a certain period of time and output a driving signal to the servomotor 700 at a certain time to withdraw the tape drive 300 from the rotation unit 600. Thereby, the actuator 640 does not operate for a long time and power consumption may be reduced, for example. The controller board 920 recognizes that preparation for use as the magnetic tape device with the autoloader function has been finished, and starts controlling the tape drive 300 and the servomotors 700 and 864 in response to the command from the host control device.

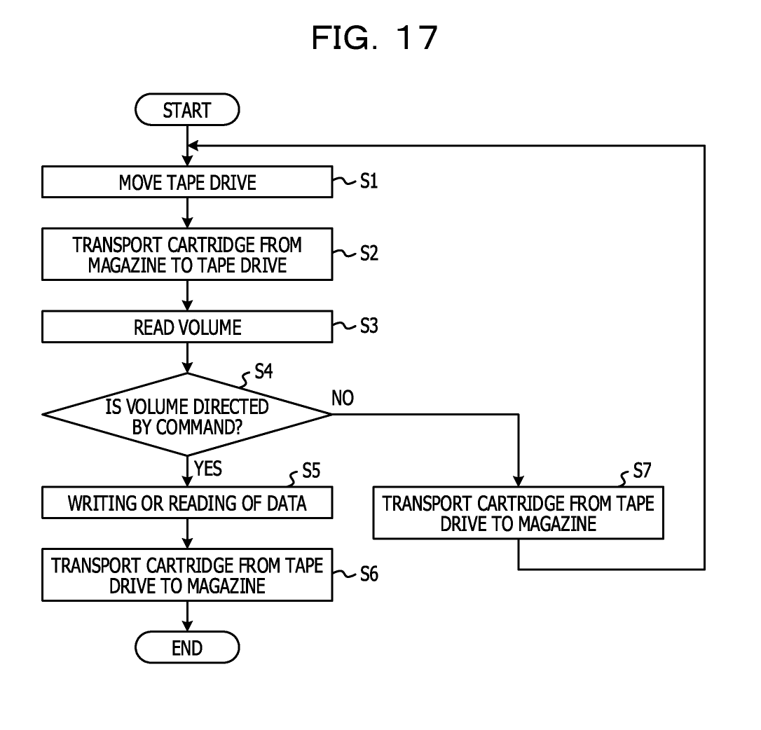

FIG. 17 illustrates an example of a backup operation. FIG. 17 illustrates the backup operation which the controller board 920 executes upon receipt of a command to read or write data from the host control device. The command from the host control device may include a volume which specifies which magnetic tape cartridge 400 data is to be read from or written to.

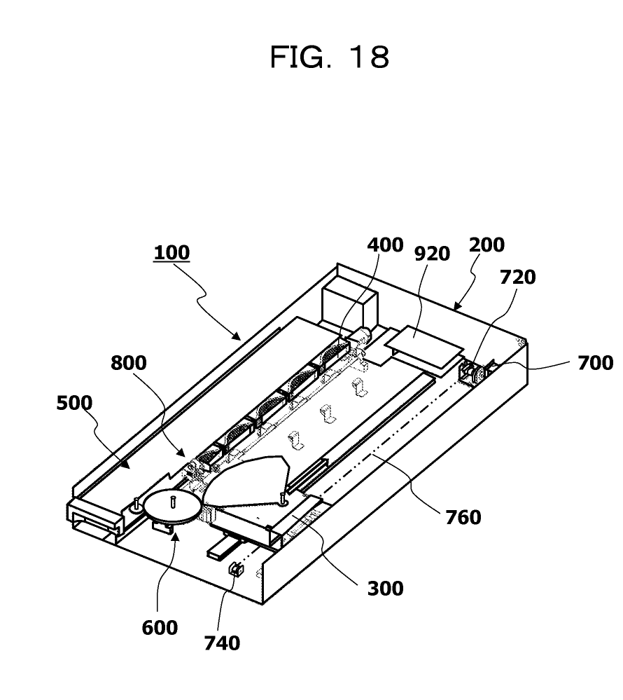

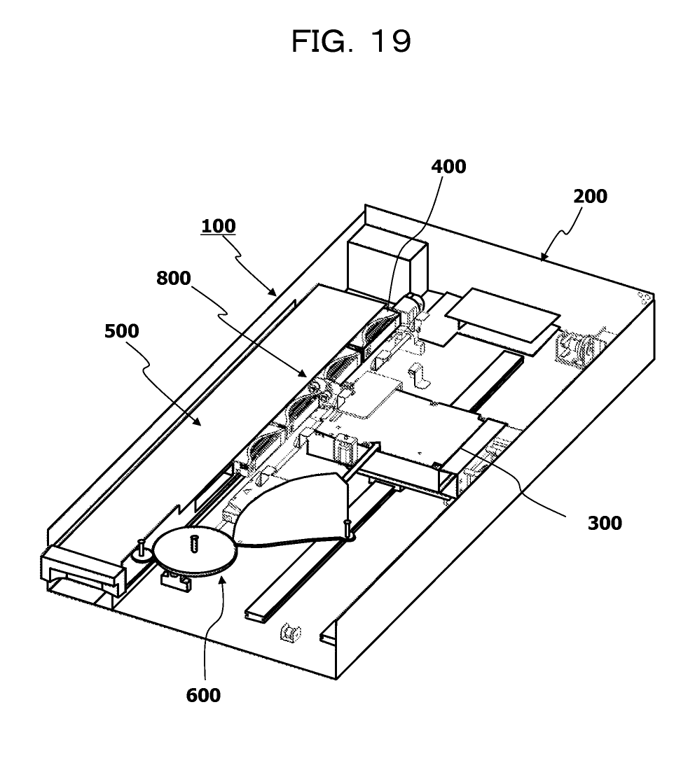

FIG. 18 illustrates an example of a method for movement of a tape drive. In operation 1 (S1), the controller board 920 outputs the driving signal to the servomotor 700. As illustrated in FIG. 18, the servomotor 700 moves the tape drive 300 to the position directly facing the magnetic tape cartridges 400. FIG. 19 illustrates an example of an order in which a tape drive moves. For example, the positions to which the tape drive 300 moves may be such that, as illustrated in FIG. 19, the first movement is set to the position closest to the front of the cabinet 200; the second movement is set to the second closest position; and the third movement is set to the third closest position.

When the tape drive 300 is moved to the position directly facing the magnetic tape cartridges 400, in the transport unit 800, the roller 832 of the first transport member 820 runs up onto the first block 866, and also, the roller 854 of the second transport member 840 runs up onto the second block 868. As illustrated in FIG. 11, the first transport member 820 and the second transport member 840 swing to pinch the magnetic tape cartridge 400 between the rollers 826 and 846 mounted to leading end portions of the first and second transport members 820 and 840, respectively.

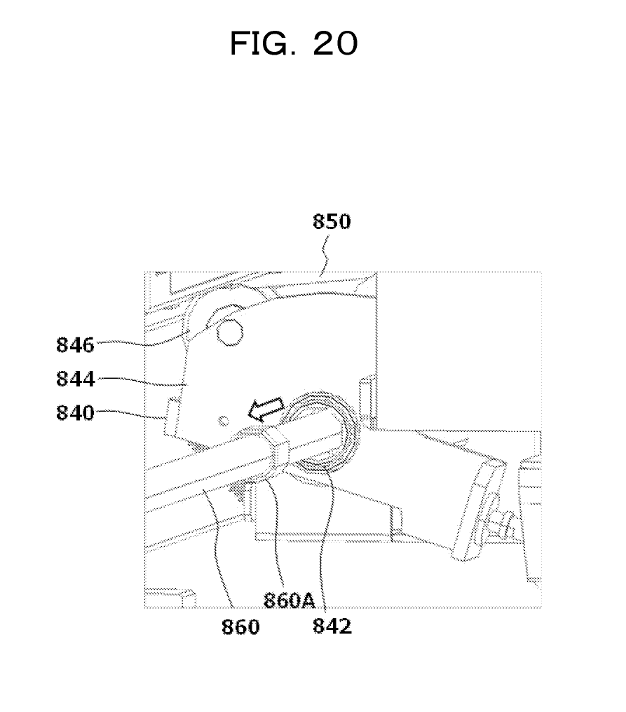

FIG. 20 illustrates an example of a transport unit. FIG. 20 illustrates an enlarged partial view illustrating operation of the transport unit. In response to the movement of the tape drive 300, as illustrated in FIG. 20, the relative positions of the cylindrical portion 842 of the second transport member 840 and the rotatable drive shaft 860 change, and thereby, at a position where the tape drive 300 is stopped, the large diameter portion 860A of the rotatable drive shaft 860 is fitted in the hole in the cylindrical portion 842. Thus, preparation for rotation of the roller 846 of the second transport member 840 by rotation of the rotatable drive shaft 860 is finished.

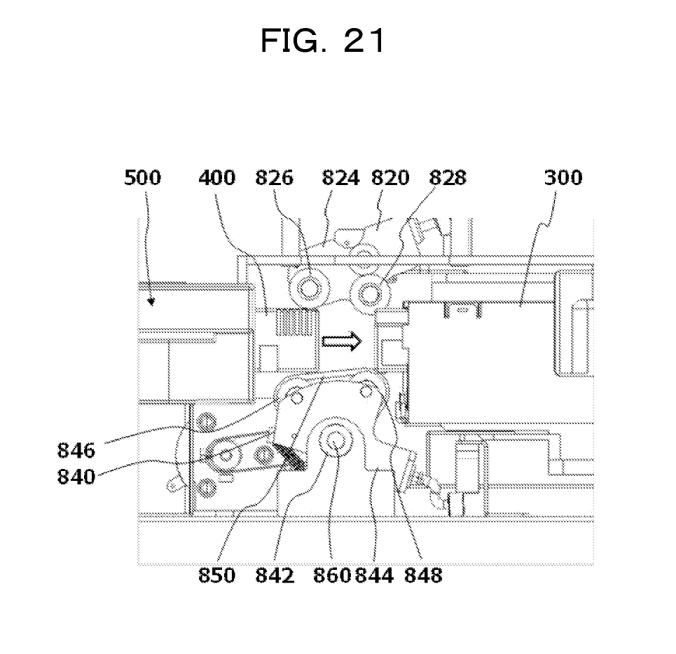

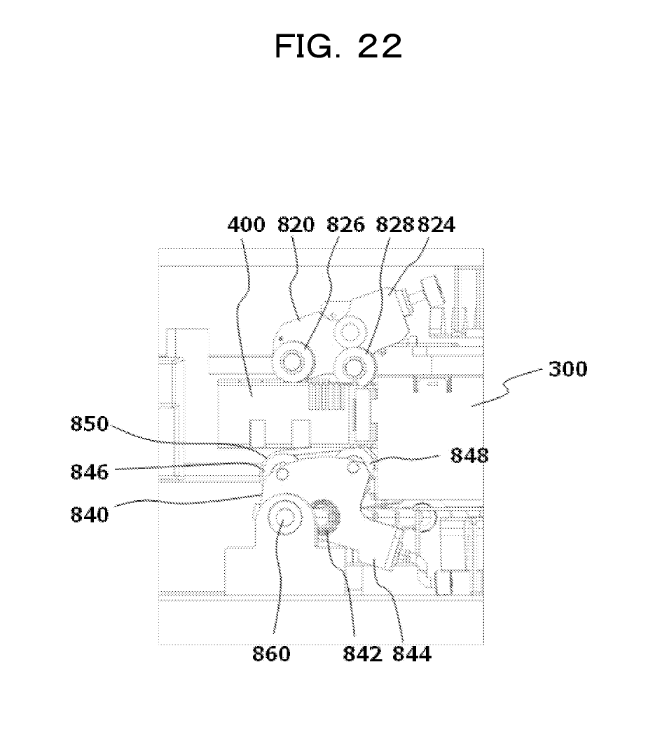

FIGS. 21 and 22 illustrate an example of a transport of a transport unit. FIG. 21 illustrates a state of start of the transport of the magnetic tape cartridge by the transport unit. FIG. 22 illustrates a state of completion of the transport of the magnetic tape cartridge by the transport unit. In operation 2, the controller board 920 outputs the driving signal to the servomotor 864, and the magnetic tape cartridge 400 contained in the magazine 500 is transported to the tape drive 300, as illustrated in FIG. 21. For example, when the rotatable drive shaft 860 is rotated by the servomotor 864, the cylindrical portion 842 of the second transport member 840 fitted with the large diameter portion 860A of the rotatable drive shaft 860 rotates. The rotation of the cylindrical portion 842 is transmitted via the belt 850 to the rollers 846 and 848. By rotating forces of the rollers 846 and 848 of the second transport member 840, the magnetic tape cartridge 400 is transported from the magazine 500 to the tape drive 300, as illustrated in FIG. 22. At this time, although the rollers 826 and 828 of the first transport member 820 do not rotate, the rollers 826 and 828 may function as auxiliary rollers to pinch the magnetic tape cartridge 400 therebetween.

In operation 3, the controller board 920 outputs a volume reading command to the tape drive 300, and the volume is read from the magnetic tape cartridge 400.

In operation 4, the controller board 920 compares the volume read from the magnetic tape cartridge 400 with the volume directed by the command from the host control device, thereby to determine whether or not the magnetic tape cartridge 400 inserted in the tape drive 300 is the magnetic tape cartridge directed by the command. If the controller board 920 determines that the volume read from the magnetic tape cartridge 400 is identical to the volume directed by the command from the host control device, the operation goes to operation 5 (Yes). If the controller board 920 determines that the volume read from the magnetic tape cartridge 400 is different from the volume directed by the command from the host control device, the operation goes to operation 7 (No).

In operation 5, the controller board 920 executes the writing or reading of data to or from the magnetic tape cartridge 400 inserted in the tape drive 300, in response to the command from the host control device.

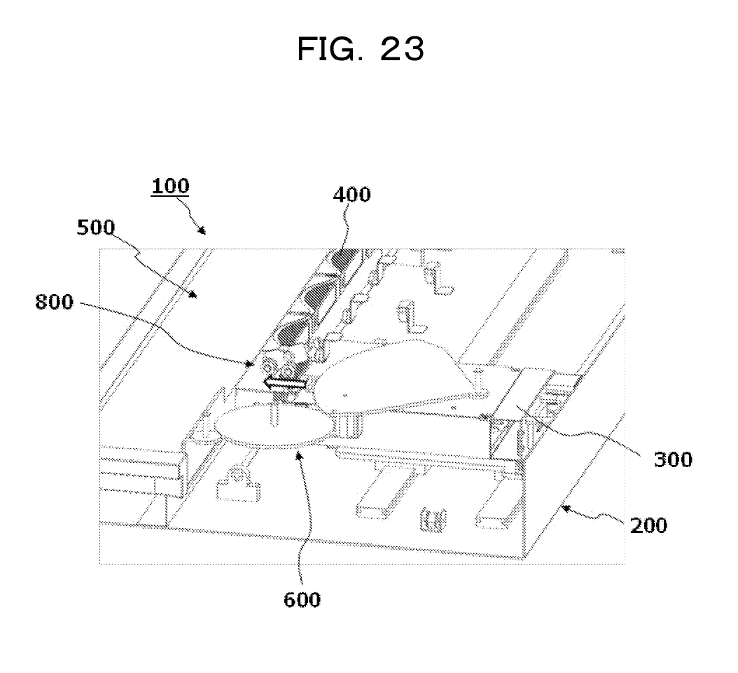

FIG. 23 illustrates an example of an ejection of a transport unit. FIG. 23 illustrates a state of ejection of the magnetic tape cartridge by the transport unit. In operation 6, the controller board 920 outputs a reverse driving signal to the servomotor 864, and the magnetic tape cartridge 400 inserted in the tape drive 300 is transported to the magazine 500, as illustrated in FIG. 23.

In operation 7, the controller board 920 outputs the reverse driving signal to the servomotor 864, and the magnetic tape cartridge 400 inserted in the tape drive 300 is transported to the magazine 500, as illustrated in FIG. 23. The operation returns to operation 1 in order that the controller board 920 executes operations 1 to 4 on another magnetic tape cartridge 400.

Thereby, when the magazine 500 is inserted into the cabinet 200, the tape drive 300 rotates to the second position directly facing the magnetic tape cartridges 400, and the data backup operation is executed in response to the command from the host control device. Thus, after the operator has inserted the magazine 500, for example, automated data backup may be performed at night.

A piece of the magnetic tape device 100 is switched to the single-unit magnetic tape device or the magnetic tape device with the autoloader function according to whether or not the magazine 500 is inserted in the cabinet 200. During time periods in which the operator's operation is expectable, the magnetic tape device 100 is used as the single-unit magnetic tape device. Thus, after the insertion of the magnetic tape cartridges 400, the data backup is started in a short time, and a reduction in efficiency of the backup may be suppressed. During time periods in which the operator's operation is not expectable, the magnetic tape device 100 is used as the magnetic tape device with the autoloader function. Thus, the automated data backup is performed on the plural magnetic tape cartridges 400.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic tape device, comprising:
a base member movable in a front-back direction of a cabinet;
a tape drive mounted rotatably to the base member at least between a first position facing a front surface of the cabinet and a second position facing a side surface of the cabinet; and
a rotation unit configured to rotate the tape drive from the first position to the second position when a magazine detachably containing a magnetic tape cartridge is inserted into the cabinet, and to rotate the tape drive from the second position to the first position when the magazine is removed from the cabinet.

2. The magnetic tape device according to claim 1, wherein the base member is movably mounted to a pair of rails extending in the front-back direction of the cabinet.

3. The magnetic tape device according to claim 1, wherein the rotation unit includes:
a rack formed on a side surface of the magazine; and
a gear train configured to mesh with the rack of the magazine and rotate the tape drive.

4. The magnetic tape device according to claim 3, wherein the gear train includes:
a first gear arranged concentric with a rotating shaft of the tape drive; and
a second gear configured to mesh with the rack of the magazine.

5. The magnetic tape device according to claim 3, wherein the rotation unit further includes an actuator fixed to the tape drive and provided with a pin to be fitted in a fitting hole formed in the first gear.

6. The magnetic tape device according to claim 1, further comprising a spring plunger protruding from a lower surface of the tape drive toward the base member.

7. The magnetic tape device according to claim 6, further comprising an arcuate groove formed in an upper surface of the base member to be movably fitted by the spring plunger.

8. The magnetic tape device according to claim 7, further comprising spherical holes formed in both end portions of the arcuate groove to be fitted by the spring plunger when the tape drive rotates to the first position or the second position.

9. The magnetic tape device according to claim 1, wherein the base member is mounted with a transport unit configured to transport the magnetic tape cartridge between the tape drive and the magazine.

10. The magnetic tape device according to claim 9, wherein the transport unit includes:
a pair of upper and lower swinging plate portions swingably fixed around a rotating shaft extending in the front-back direction of the cabinet;
at least one first roller fixed in a lower portion of the upper swinging plate portion;
at least one second roller fixed in an upper portion of the lower plate portion; and
a driving unit configured to rotatably drive the at least one second roller.

11. The magnetic tape device according to claim 9, wherein the transport unit includes a pinching unit configured to swing the pair of swinging the pair of upper and lower swinging plate portions and to pinch the magnetic tape cartridge between the pair of upper and lower swinging plate portions, when the tape drive moves to a position directly facing the magnetic tape cartridge contained in the magazine.

12. The magnetic tape device according to claim 11, wherein the pinching unit includes a block whose height changes along the front-back direction of the cabinet.

13. The magnetic tape device according to claim 10, wherein the driving unit includes:
a cylindrical portion having a cylindrical shape about which the lower swinging plate portion swings;
a belt provided between the cylindrical portion and the second roller;
a rotatable drive shaft, including a portion which faces the magnetic tape cartridge, has a diameter larger than the other portions of the rotatable drive shaft and has a noncircular shape, and extending through a center of the cylindrical portion; and
an actuator configured to rotate the rotatable drive shaft.

14. A magnetic tape device, comprising:
a base member movable in a front-back direction of a cabinet;
a tape drive rotatably mounted to the base member;
a rotation unit configured to rotate the tape drive according to insertion or removal of a magazine detachably containing a magnetic tape cartridge; and
a transport unit configured to move the magnetic tape cartridge to the tape drive after the tape drive faces the magnetic tape cartridge by rotation by the rotation unit.

15. The magnetic tape device according to claim 14, wherein the base member is movably mounted to a pair of rails extending in the front-back direction of the cabinet.

16. The magnetic tape device according to claim 14, wherein the rotation unit includes:
a rack formed on a side surface of the magazine; and
a gear train configured to mesh with the rack of the magazine and rotate the tape drive.

17. The magnetic tape device according to claim 14, further comprising a spring plunger protruding from a lower surface of the tape drive toward the base member.

18. A method for controlling a magnetic tape device, comprising:
inserting a magazine detachably containing a magnetic tape cartridge, from a front surface of a cabinet of the magnetic tape device;
changing an orientation of a magnetic tape cartridge insertion port of a tape drive, from the front surface of the cabinet to a side surface of the cabinet on the side on which the magazine is inserted, based on the inserting of the magazine;
transporting the magnetic tape cartridge from the magazine to the tape drive; and
executing reading or writing of data from or to the magnetic tape cartridge.
